(19) United States
(12) Patent Application Publication
(10) Pub. No.: US 2025/0043186 A1
(43) Pub. Date: Feb. 6, 2025

(54) FIRE-RETARDANT COMPOSITIONS AND INSULATION MATERIALS AND METHOD OF MAKING

(71) Applicant: Applegate Greenfiber Acquisition, LLC, Charlotte, NC (US)

(72) Inventors: Marvin Lee Johnson, Williamston, MI (US); Todd Arthur Wannemacher, Ottoville, OH (US); Jacob Matthew Plummer, Wingate, NC (US); Ernest Scott Haigler, Marshville, NC (US)

(21) Appl. No.: 18/792,182

(22) Filed: Aug. 1, 2024

Related U.S. Application Data
(60) Provisional application No. 63/517,562, filed on Aug. 3, 2023.

(51) Int. Cl. C09K 21/10; C08J 3/22; C08K 3/38; C08K 5/21; C08L 1/02; C09K 21/02; E04B 1/94

(52) U.S. Cl. CPC C09K 21/10; C08J 3/226; C08K 3/38; C08K 5/21; C08L 1/02; C09K 21/02; E04B 1/941; C08J 2301/02; C08J 2371/02; C08L 2201/02; C08L 2205/16; C08L 2207/20; C08L 2310/00

(57) ABSTRACT

Disclosed herein are fire-retardant compositions including a borate compound, urea, and, optionally, a surfactant. Also disclosed are fire-retardant insulations materials including the disclosed fire-retardant compositions and cellulose fiber insulation. Further disclosed are methods for making the same.

### CROSS-REFERENCE TO RELATED APPLICATIONS

This application claims priority to U.S. Provisional Application No. 63/517,562, filed Aug. 3, 2023, the entire contents of which are incorporated herein by reference.

Disclosed herein are fire-retardant compositions including a borate compound, urea, and, optionally, a surfactant. Also disclosed are fire-retardant insulations materials including the disclosed fire-retardant compositions and cellulose fiber insulation. Further disclosed are methods for making the same.

Fire-retardant compositions are useful for preventing or slowing the burning of a material such as, for example, a cellulose insulation material. Cellulose insulation materials must be manufactured to meet specific fire-retardant testing requirements such as the industry standards of ASTM C739.

Most existing fire-retardant compositions for use in cellulose fiber-based insulations utilize some amount of boric acid. The use of boric acid can be costly, so that fire retardant compositions typically include alternative although less effective fire retardant chemicals, for example ammonium phosphate, gypsum, ammonium sulfate, calcium sulfate, magnesium sulfate, sodium polyborate, sodium tetraborate pentahydrate, to reduce the amount of boric acid while maintaining desired fire-retardant properties. However, there are several drawbacks to these fire-retardant compositions. First, the fire-retardant compositions may still require a relatively high concentration of boric acid. Second, ammonium containing additives can off-gas ammonia after installation. Finally, use of these materials may increase dust during installation, cause irritation to an installer, and/or are not effective fungal inhibitors.

Manufacturing, installing, and/or handling cellulose insulation materials may produce large quantities of undesirable dust. High concentrations of boric acid in the fire-retardant may cause a high level of chemical dust to become airborne during the application phase of installing the cellulose insulation. This dust can be a nuisance to workers installing the product as an irritant and hamper visibility. Some alternative components to boric acid, however, may have negative factors that make them less than ideal for use in a fire-retardant composition.

### SUMMARY OF THE INVENTION

There is a continuing need for economical and efficacious fire-retardant compositions and fire-retardant insulation materials, in particular cellulose insulation materials, that can also reduce the amount of dust formed during, e.g., installation while conferring adequate fire-retardancy.

Disclosed are fire-retardant compositions including from 15 weight % to 85 weight % of a borate compound by total weight of the fire-retardant composition, from 15 weight % to 85 weight % of urea by total weight of the fire-retardant composition, and from 0 weight % to 3 weight % of a surfactant by total weight of the fire-retardant composition. In some embodiments, the weight ratio of the borate compound to urea can range from 15:85 to 85:15. Also disclosed are fire-retardant composition including a borate compound and urea in a weight ratio ranging from 15:85 to 85:15, and from 0 weight % to 3 weight % of a surfactant by total weight of the fire-retardant composition, in which the weight % of the borate compound plus the weight % of urea ranges from 50% to 100% of the fire-retardant composition.

In some embodiments, the weight % of borate compound plus the weight % of urea ranges from 97% to 100%.

Also disclosed are fire-retardant insulation material including a cellulose fiber insulation, and a fire-retardant composition as disclosed herein, wherein the fire-retardant insulation material is formulated to have a fire-retardance that meets or exceeds ASTM C739 testing standards.

In some embodiments, the fire-retardant insulation material has from 85 weight % to 90 weight % of the cellulose fiber insulation by total weight of the fire-retardant insulation material, and from 10 weight % to 15 weight % of the fire-retardant composition by total weight of the fire-retardant insulation material.

Further disclosed are processes for preparing a fire-retardant insulation material including shredding a reclaimed cellulose feedstock to obtain a shredded cellulose material having a fiber size ranging from 0.5 inches to 3 inches, milling a fire-retardant composition as disclosed herein, and contacting the shredded cellulose material the milled fire-retardant composition to obtain the fire-retardant insulation material.

In some embodiments, the fire-retardant composition is milled at a temperature ranging from 60° F. to 120° F., for example 65° F. to 110° F.

In some embodiments, the fire-retardant composition is milled at 1,500 to 2,500 revolutions per minute in the presence of 1,300 to 2,500 cubic feet per minute of airflow.

### BRIEF DESCRIPTION OF THE FIGURES

FIG. 1 depicts a schematic view of a process and equipment for preparation of the Fire-Retardant composition.

### DETAILED DESCRIPTION

As used herein, a “reclaimed cellulose feedstock” is a cellulose material that is to be recycled. Reclaimed cellulose feedstocks include, for example, pre- and post-consumer old newspapers and various post-industrial fibers such as double lined kraft and solid unbleached sulfate paperboard. A reclaimed cellulose feedstock is converted to a recycled cellulose if, for example, the reclaimed cellulose feedstock is used to make a cellulose insulation material.

Unless otherwise stated, all parts and percentages are by weight. As used herein, the term “about” refers to plus or minus 10% of the indicated value. Unless otherwise stated, weight percentages are provided based on the total amount of the composition in which they are described. As used herein, the singular forms “a,” “an,” and “the” include the plural unless stated otherwise.

As used herein, a “borate compound” is a compound, including a free acid or salt, that contains a borate (BO₃—) moiety, including acids and salts. Exemplary borate compounds include orthoboric acid, borate salts such as sodium borate, and borax.

As used herein, the term “surfactant” has its ordinary meaning, i.e. a compound or composition that reduces the surface tension of water. Surfactants can be anionic, cationic, or nonionic (neutral). Examples of surfactants include sodium lauryl sulfate, alkyldimethylamine oxides, alkoxylated alcohols, alkoxylated fatty acids, alkaryl polyoxylkane ethers and related compounds known in the art.

Surfactants can include alkoxyated compounds, i.e., compounds having the chemical group:

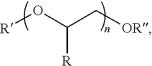

wherein R is H or methyl, R′ and R″ are independently H or a hydrophobic group, and n can vary from 5-100. Exemplary hydrophobic groups include, but are not limited to alkyl, for example C9-C30 alkyl; fatty acid acyl, for example C12-C30 linear or branched fatty acid acyl; sorbitan or other sugars and dehydrated sugars which may also be alkoxylated; aryl; and alkylaryl. In some embodiments, the surfactant is ethoxylated, i.e. contains the group

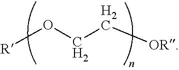

Exemplary non-ionic surfactants includes an alkylaryl compound having the formula:

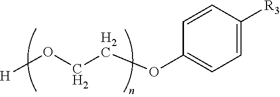

wherein R₃ is a linear or branched hydrocarbon and n ranges from 5 to 100. In some embodiments, R₃ is a linear or branched nonyl group.

Non-limiting examples of commercially available surfactants that may be used in the invention include
Tergitol™ NP-30 (Dow Chemical, Midland, MI) —an alkylaryl compound in which R is nonyl and n is an average of 30;
Polyoxyethylene sorbitan monooleate (e.g., Polysorbate 80);
Hydretain® ES Plus Granular QD (Ecologel Solutions, Ocala, FL) —54% plant based sugar alcohols, polysaccharides, and neutral salts of alpha-hydroxypropionic acid, 10% non-ionic surfactant, and 36% inert ingredients;
Helena Induce@(Helena Agri-Enterprises, Collierville, TN) —a combination of alkaryl polyoxylkane ethers, alkanolamides, dimethyl siloxane, and free fatty acids;
Helena Kinetic@(Helena Agri-Enterprises, Collierville, TN) —a combination of polyalkyleneoxide modified polydimethylsiloxane and nonionic surfactant;
Dawn@Ultra Dishwashing Liquid (Proctor & Gamble)—a combination of mono-C10-16-alkyl esters, poly(oxy-1,2-ethanediyl), alpha-sulfo-omega-hydroxy-, C10-16-alkyl ethers, sodium salts, Amine oxides, C10-16-alkyldimethyl, and ethanol; and combinations thereof. Other surfactants, in particular non-ionic surfactants, can also be used.

### Fire-Retardant Compositions

Disclosed herein are fire-retardant compositions including borate compound, urea, and, optionally, a surfactant. In some embodiments, the fire-retardant composition includes from 15 weight % to 85 weight % of borate compound by total weight of the fire-retardant composition, from 15 weight % to 85 weight % of urea by total weight of the fire-retardant composition, and from 0 weight % to 3 weight % of a surfactant by total weight of the fire-retardant composition. For example, the fire-retardant composition according to the disclosure may include from 15 weight % to 85 weight % of a borate compound by total weight of the fire-retardant composition, from 15 weight % to 85 weight % of urea by total weight of the fire-retardant composition, and from 0 weight % to 3 weight % of a surfactant by total weight of the fire-retardant composition.

In some embodiments, the fire-retardant compositions include from 25 weight % to 75 weight % of a borate compound by total weight of the fire-retardant composition, from 25 weight % to 75 weight % of urea by total weight of the fire-retardant composition, and from 0 weight % to 3 weight % of a surfactant by total weight of the fire-retardant composition. In some embodiments, the weight ratio of the borate compound to urea can range from 25:75 to 75:25. Also disclosed are fire-retardant composition including a borate compound and urea in a weight ratio ranging from 25:72 to 75:25, and from 0 weight % to 3 weight % of a surfactant by total weight of the fire-retardant composition, in which the weight % of borate compound plus the weight % of urea ranges from 50% to 100% of the fire-retardant composition.

In some embodiments, the fire-retardant compositions include 70 weight % of a borate compound by total weight of the fire-retardant composition, 30 weight % of urea by total weight of the fire-retardant composition, and from 0 weight % to 3 weight % of a surfactant by total weight of the fire-retardant composition. In some embodiments, the fire-retardant compositions include 60 weight % of a borate compound by total weight of the fire-retardant composition, 40 weight % of urea by total weight of the fire-retardant composition, and from 0 weight % to 3 weight % of a surfactant by total weight of the fire-retardant composition. In some embodiments, the fire-retardant compositions include 50 weight % of a borate compound by total weight of the fire-retardant composition, 50 weight % of urea by total weight of the fire-retardant composition, and from 0 weight % to 3 weight % of a surfactant by total weight of the fire-retardant composition. In some embodiments, the fire-retardant compositions include 40 weight % of a borate compound by total weight of the fire-retardant composition, 60 weight % of urea by total weight of the fire-retardant composition, and from 0 weight % to 3 weight % of a surfactant by total weight of the fire-retardant composition.

Also disclosed are fire-retardant compositions including a borate compound and urea in a weight ratio ranging from 15:85 to 85:15, and from 0 weight % to 3 weight % of a surfactant by total weight of the fire-retardant composition, in which the weight % of the borate compound plus the weight % of urea ranges from 50% to 100% of the fire-retardant composition. Also disclosed are fire-retardant compositions including orthoboric acid and urea in a weight ratio ranging from 25:75 to 75:25, and from 0 weight % to 3 weight % of a surfactant by total weight of the fire-retardant composition, in which the weight % of orthoboric acid plus the weight % of urea ranges from 50% to 100% of the fire-retardant composition.

In some embodiments, the borate compound is selected from orthoboric acid, borate salts such as sodium borate, and borax. In some embodiments, the borate compound is orthoboric acid.

It was surprisingly found that fire-retardant compositions of the invention used in cellulose-based insulation material can be manufactured with smaller amounts of boric acid than required when using other additives and also result in unexpectedly low amounts of dust during, e.g., installation and handling of the insulation, as compared to existing fire-retardant compositions. The amount of dust during handling and installation may be determined by, for example, video recording the installation process and comparing the amount of dust present when installing different insulation materials. Without wishing to be bound by theory, it is believed that hydrogen bonding interactions between, e.g., the borate compound and urea and/or water result in unexpectedly reduced amounts of dust.

The interaction modifying effects of one or more surfactants such as a non-ionic surfactant, may further contribute to the unexpectedly reduced amounts of dust. In some embodiments, fire-retardant compositions may include from 0 weight % to 3 weight % of a surfactant by total weight of the fire-retardant composition. In some embodiments, fire-retardant compositions may include from 1 weight % to 3 weight % of the surfactant by total weight of the fire-retardant composition. Surprisingly, the inclusion of a surfactant further enhances the properties of the fire-retardant composition by, for example, reducing the amount of dust generated during handling and/or installation. Without wishing to be bound by theory, it is believed that such surfactants favorably interact with the borate compound and urea, for example, by complexing with these compounds and/or influencing the hydrogen bonding of these compounds, and this favorable interaction reducing the amount of dust generated during handling and/or installation of a fire-retardant insulation material.

In some embodiments, the one or more surfactants include anionic, cationic, or nonionic (neutral) surfactants. Examples of surfactants include sodium lauryl sulfate, alkyldimethylamine oxides, alkoxylated alcohols, alkoxylated fatty acids, alkaryl polyoxylkane ethers and related compounds known in the art. In some embodiments the one or more surfactants include an alkoxylated alkyl phenol, for example Tergitol™ NP-30. Other surfactants, in particular non-ionic surfactants, can also be used. In some embodiments, the one or more surfactants include alkoxylated, for example ethoxylated, alkyl alcohol. Exemplary alkyl alcohols include C9-C30 linear or branched alcohols. In some embodiments, the one or more surfactants include an alkoxylated, for example ethoxylated, fatty acid. Exemplary fatty acids include C12-C30 linear or branched fatty acids. In some embodiments, the one or more surfactants include polyoxyethylene sorbitan monooleate (e.g., Polysorbate 80).

In some embodiments, the fire-retardant composition includes at least one surfactant chosen from Tergitol™ NP-30 (Dow Chemical, Midland, MI an alkylaryl compound in which R is nonyl and n is an average of 30); Polysorbate 80 (polyoxyethylene sorbitan monooleate); Hydretain® ES Plus Granular QD (Ecologel Solutions, Ocala, FL—54% plant based sugar alcohols, polysaccharides, and neutral salts of alpha-hydroxypropionic acid, 10% non-ionic surfactant, and 36% inert ingredients); Helena Induce@(Helena Agri-Enterprises, Collierville, TN—a combination of alkaryl polyoxylkane ethers, alkanolamides, dimethyl siloxane, and free fatty acids); Helena Kinetic@(Helena Agri-Enterprises, Collierville, TN—a combination of polyalkyleneoxide modified polydimethylsiloxane and nonionic surfactant); Dawn® Ultra Dishwashing Liquid (Proctor & Gamble—a combination of mono-C10-16-alkyl esters, poly(oxy-1,2-ethanediyl), alpha-sulfo-omega-hydroxy-, C10-16-alkyl ethers, sodium salts, Amine oxides, C10-16-alkyldimethyl, and ethanol; and combinations thereof.

In some embodiments, the weight % of a borate compound plus the weight % of urea ranges in the fire-retardant composition ranges from 97% to 100%. In some embodiments, the weight ratio of a borate compound to urea ranges from 15:85 to 50:50. In some embodiments, the weight ratio of a borate compound to urea ranges from 15:85 to 35:65. In some embodiments, the weight ratio of a borate compound to urea ranges from 30:70 to 40:60. In some embodiments, the weight ratio of a borate compound to urea is 30:70.

Boric acid containing fire-retardant composition in the prior art have attempted to reduce boric acid content by including additives to enhance fire retardancy of cellulose fiber insulation. Non-limiting examples of such additives include ammonium compounds (sulfate and phosphates), magnesium sulfate, calcium sulfate, sodium polyborate, and sodium tetraborate pentahydrate. However, these additives have negative effects that make them less than ideal for use in the fire-retardant insulation materials. For example use of ammonium sulfate, magnesium sulfate, sodium polyborate, calcium sulfate dihydrate and sodium tetraborate pentahydrate, can result high levels of dust during application of the insulation. Ammonium sulfate can also emit a strong unpleasant ammonia odor. Magnesium sulfate is highly hygroscopic which can cause significant storage and processing challenges. Calcium sulfate dihydrate can also have poor fire-retardant efficacy.

In some embodiments, additives to the fire-retardant composition other than urea, boric acid, and surfactant are present in amounts up to 50 weight % of the fire-retardant composition. In other words, the weight % of a borate compound plus the weight % of urea ranges from 50% to 100%. These additives may include, for example, ammonium sulfate, magnesium sulfate, sodium polyborate, calcium sulfate dihydrate, inert ingredients and combinations thereof.

However, in some exemplary embodiments, the fire-retardant composition is free from or substantially free from other additives such as ammonium compounds (sulfate and phosphates), magnesium sulfate, calcium sulfate, sodium polyborate, and sodium tetraborate pentahydrate. As used herein, “free from” means that the fire-retardant composition contains no added compound. As used herein, “substantially free from” means that if the additive is present in the fire-retardant composition, it is present in an amount of less than or equal to 1 weight %, for example less than or equal to 0.1 weight %, or less than or equal to 0.01 weight %. Accordingly, free from or substantially free from means 0 weight %, of the additive, 0 weight % to 1 weight % of the additive, 0 weight % to 0.1 weight % of the additive, or 0 weight % to 0.01 weight % of the additive. In some embodiments, the fire-retardant composition has from 0 weight % to 1 weight %, from 0 weight % to 0.1 weight %, or from 0 weight % to 0.01 weight % ammonium sulfate by total weight of the fire-retardant composition. In some embodiments, the fire-retardant composition is free from ammonium sulfate. In some embodiments, the fire-retardant composition has from 0 weight % to 1 weight %, from 0 weight % to 0.1 weight %, or from 0 weight % to 0.01 weight % magnesium sulfate by total weight of the fire-retardant composition. In some embodiments, the fire-retardant composition is free from magnesium sulfate. In some embodiments, the fire-retardant composition has from 0 weight % to 1 weight %, from 0 weight % to 0.1 weight %, or from 0 weight % to 0.01 weight % sodium polyborate by total weight of the fire-retardant composition. In some embodiments, the fire-retardant composition is free from sodium polyborate. In some embodiments, the fire-retardant composition has from 0 weight % to 1 weight %, from 0 weight % to 0.1 weight %, or from 0 weight % to 0.01 weight % calcium sulfate by total weight of the fire-retardant composition. In some embodiments, the fire-retardant composition is free from calcium sulfate. In some embodiments, the fire-retardant composition has from 0 weight % to 1 weight %, from 0 weight % to 0.1 weight %, or from 0 weight % to 0.01 weight % sodium tetraborate pentahydrate by total weight of the fire-retardant composition. In some embodiments, the fire-retardant composition is free from sodium tetraborate pentahydrate. In some embodiments, the total amount of ammonium compounds (sulfate and phosphates), calcium phosphate, calcium sulfate, magnesium phosphate, sodium polyborate, and sodium tetraborate pentahydrate is from 0 weight % to 1 weight %, from 0 weight % to 0.1 weight %, or from 0 weight % to 0.01 weight % sodium polyborate by total weight of the fire-retardant composition. In some embodiments, the fire-retardant composition is free from ammonium compounds (sulfate and phosphates), calcium phosphate, calcium sulfate, magnesium phosphate, sodium polyborate, and sodium tetraborate pentahydrate.

In some embodiments, fire-retardant composition consists essentially of the borate compound, the urea, and, optionally, the surfactant. In some embodiments, fire-retardant composition consists essentially of the borate compound, the urea, and the surfactant. Embodiments that consist essentially of the borate compound, the urea, and, optionally, the surfactant may further include some compounds such as, for example, water and/or a dye.

In some embodiments, the fire-retardant composition consists of the borate compound, the urea, and, optionally, the surfactant. In some embodiments, fire-retardant composition consists of the borate compound, the urea, and the surfactant. In some embodiments, fire-retardant composition consists of the borate compound, the urea, and, optionally, the surfactant. In some embodiments, fire-retardant composition consists of the borate compound, the urea, and the surfactant.

### Processes for Making Fire-Retardant Composition

Process deficiencies are observed when the disclosed fire-retardant composition is produced using typical operating temperatures for preparing prior art compositions. In particular, urea can become molten during the chemical grinding process which can lead to plugged chemical grinding mills and subsequent piping. For at least this reason fire-retardant compositions can be prepared by milling under conditions that control the air flow and temperature. This can be accomplished by thermostatically controlling milling temperatures, controlling milling conditions and speeds, and/or controlling air flows. In some embodiments, a chiller cools air and the cooled air is provided to the chemical grinding mill.

In some embodiments, the fire-retardant compositions are processed in a chemical grinding apparatus, such as, for example, a Reynolds 22H or 28H chemical mill. In some embodiments, the fire-retardant composition is ground to a particle size with a minimum of 90 weight % passing through a 325-mesh or 44-micron sieve. In some embodiments, the particle size is important for effective bonding with the cellulose fibers.

In some embodiments, fire-retardant composition is milled at a temperature maintained at under 120° F., for example a temperature ranging from 60° F. to 120° F., for example 65° F. to 110° F. In some embodiments, the drive motor of the mill is slowed from 60 Hz to 50 Hz. In some embodiments, the fire-retardant composition is milled at 2,000 to 2,500 revolutions per minute. In some embodiments, air flow in the mill is controlled to 1,300 to 2,500 cubic feet per minute.

### Fire-Retardant Insulation Materials

Disclosed are fire-retardant insulation materials including a cellulose fiber insulation, and a fire-retardant composition as disclosed herein. The fire-retardant insulation material can be formulated with cellulose fiber insulation and the fire-retardant composition to have a fire-retardance that meets or exceeds ASTM C739 testing standards.

In some embodiments, the fire-retardant insulation material has: from 85 weight % to 90 weight % of the cellulose fiber insulation by total weight of the fire-retardant insulation material, and from 10 weight % to 15 weight % of the fire-retardant composition by total weight of the fire-retardant insulation material. In some embodiments, the fire-retardant insulation material has from 12 weight % to 14 weight % of the fire-retardant composition by total weight of the fire-retardant insulation material.

In some embodiments, the fire-retardant insulation material is formulated to have a fungi resistance that meets or exceeds ASTM 739 testing standards.

In some embodiments, the fire-retardant insulation material is formulated to have a corrosion resistance that meets or exceeds ASTM 739 testing standards.

In some embodiments, the cellulose fiber insulation includes recycled cellulose. In some embodiments, the cellulose fiber insulation only recycled cellulose.

In some embodiments, the cellulose fiber insulation has a cellulose fiber size ranging from 0.25 inches to 0.50 inches.

### Processes for Making Fire-Retardant Insulation Materials

Disclosed are processes for preparing a fire-retardant insulation material, wherein the process includes shredding a cellulose feedstock, for example a reclaimed cellulose feedstock, to obtain a shredded cellulose material having a fiber size ranging from 0.5 inches to 3 inches, and contacting the shredded cellulose material with a milled fire-retardant composition to obtain the fire-retardant insulation material.

It was surprisingly found that, in some embodiments, some standard production methods for producing fire-retardant insulation materials provided unsatisfactory results. For example, some process deficiencies were observed when using typical operating temperatures such that the urea became molten during the chemical grinding process and/or plugged the chemical grinding mills and subsequent piping.

In some embodiments, the fire-retardant compositions are in a dry granule form when added to the cellulose insulation material.

Further aspects of the present disclosure are provided by the subject matter of the following clauses.

A fire-retardant composition including a borate compound and urea in a weight ratio ranging from 15:85 to 85:15, and from 0 weight % to 3 weight % of a surfactant by total weight of the fire-retardant composition, wherein the weight % of the borate compound plus the weight % of urea ranges from 50% to 100% of the fire-retardant composition.

The fire-retardant composition of the preceding clause comprising a borate compound and urea in a weight ratio ranging from 25:72 to 75:25, and from 0 weight % to 3 weight % of a surfactant by total weight of the fire-retardant composition, wherein the weight % of the borate compound plus the weight % of urea ranges from 50% to 100% of the fire-retardant composition.

The fire-retardant composition of any preceding clause comprising from 15 weight % to 85 weight % of a borate compound by total weight of the fire-retardant composition, from 15 weight % to 85 weight % of urea by total weight of the fire-retardant composition, and from 0 weight % to 3 weight % of a surfactant by total weight of the fire-retardant composition.

The fire-retardant composition of any preceding clause, wherein the fire-retardant composition including a surfactant that is an ethoxylated alkaryl compound wherein the alkyl group a linear or branched hydrocarbon and includes from 5 to 100 ethoxy units.

The fire-retardant composition of any preceding clause, wherein the weight % of the borate compound plus the weight % of urea ranges from 50% to 100% (e.g., from 97% to 100%).

A fire-retardant insulation material including cellulose fiber insulation, and the fire-retardant composition of any preceding clause, wherein the fire-retardant insulation material is formulated to have a fire-retardance that meets or exceeds ASTM C739 testing standards.

The fire-retardant insulation material of the preceding clause, wherein the fire-retardant insulation material has from 85 weight % to 90 weight % of the cellulose fiber insulation by total weight of the fire-retardant insulation material, and from 10 weight % to 15 weight % of the fire-retardant composition by total weight of the fire-retardant insulation material or from 12 weight % to 14 weight % of the fire-retardant composition by total weight of the fire-retardant insulation material.

The fire-retardant insulation material of any preceding clause, wherein the fire-retardant insulation material is formulated to have a fungi resistance that meets or exceeds ASTM 739 testing standards.

The fire-retardant insulation material of any preceding clause, wherein the fire-retardant insulation material is formulated to have a corrosion resistance that meets or exceeds ASTM 739 testing standards.

The fire-retardant insulation material of any preceding clause, wherein the cellulose fiber insulation includes recycled cellulose.

The fire-retardant insulation material of any preceding clause, wherein the cellulose fiber insulation has a cellulose fiber size ranging from 0.25 inches to 0.5 inches.

The fire-retardant insulation material of any preceding clause, wherein the fire-retardant insulation material is storage stable.

The fire-retardant composition or fire-retardant insulation material of any preceding clause, that is substantially free from ammonium sulfate.

The fire-retardant composition or fire-retardant insulation material of any preceding clause, that is substantially free from magnesium sulfate.

The fire-retardant composition or fire-retardant insulation material of any preceding clause, that is substantially free from sodium polyborate.

The fire-retardant composition or fire-retardant insulation material of any preceding clause, that is substantially free from calcium sulfate.

The fire-retardant composition or fire-retardant insulation material of any preceding clause, that is substantially free from sodium tetraborate pentahydrate.

The fire-retardant composition or fire-retardant insulation material of any preceding clause, that is free from ammonium sulfate.

The fire-retardant composition or fire-retardant insulation material of any preceding clause, that free from sodium polyborate.

The fire-retardant composition or fire-retardant insulation material of any preceding clause, that is free from calcium sulfate.

The fire-retardant composition or fire-retardant insulation material of any preceding clause, that is free from sodium tetraborate pentahydrate.

The fire-retardant composition or fire-retardant insulation material of any preceding clause, wherein the fire-retardant composition consists essentially of the borate compound, the urea, and, optionally, the surfactant.

The fire-retardant composition or fire-retardant insulation material of any preceding clause, wherein the fire-retardant composition includes a dye and/or water.

The fire-retardant composition or fire-retardant insulation material of any preceding clause, wherein the fire-retardant composition consists of the borate compound, the urea, and, optionally, the surfactant.

The fire-retardant composition or fire-retardant insulation material of any preceding clause, wherein the fire-retardant composition consists of the borate compound, the urea, the surfactant, and water.

The fire-retardant composition or fire-retardant insulation material of any preceding clause, wherein the fire-retardant composition consists of the borate compound, the urea, the surfactant, water, and, optionally, a dye.

The fire-retardant composition or fire-retardant insulation material of any preceding clause, wherein the fire-retardant composition includes from 1 weight % to 3 weight % of the surfactant by total weight of the fire-retardant composition.

The fire-retardant composition or fire-retardant insulation material of any preceding clause, wherein the fire-retardant composition includes the surfactant, and the surfactant is Tergitol™ NP-30.

The fire-retardant composition or fire-retardant insulation material of any preceding clause that does not have an odor.

A process for preparing a fire-retardant insulation material, wherein the process comprises: shredding a reclaimed cellulose feedstock to obtain a shredded cellulose material having a fiber size ranging from 0.5 inches to 3 inches, milling a fire-retardant composition of any preceding clause, and contacting the shredded cellulose material the milled fire-retardant composition to obtain the fire-retardant insulation material.

The process according to the preceding clause, wherein fire-retardant composition is milled at a temperature ranging from 60° F. to 120° F.

The process according to the preceding clause, wherein fire-retardant composition is milled at a temperature ranging from 65° F. to 110° F.

The process according to any preceding clause, wherein fire-retardant composition is milled at 2,000 to 2,500 revolutions per minute in the presence of 1,300 to 2,500 cubic feet per minute of airflow.

### EXAMPLES

The following examples are provided for illustrative purposes only and are not intended to limit the scope of the disclosure.

Fire-retardant insulation materials were prepared according to the following example procedure.

### Preparation of Cellulose Fibers

The manufacturing process begins with sourcing recycled fibers as the base component for cellulose insulation. These fibers may be pre- and post-consumer old newspapers (ONP) and various post-industrial fibers such as double lined kraft (DLK) and solid unbleached sulfate (SUS) paperboard.

This fiber stock, depending on size, is conveyed across a sorting system to remove any prohibitive contents, such as plastics or metals. The cleaned feedstocks are then metered through a shear shredder such as a ShredTech device to begin the process of downsizing the feedstock to a size of approximately 6″.

The various feedstocks are then blended to a formulation specified by a set percentage of each fiber grade. That fiber blend is metered and conveyed into a shredder and hammermill such as a Bliss Mill, to further reduce the fiber size to approximately 1-2″. The shredded fiber is pneumatically conveyed through a material handling fan through a cyclone with the fiber falling into a paper metering tank and the dirty air going through a dust filtering system. The metering tank mechanically augers the fiber onto a conveyor transferring the fiber into a disc refiner for the final process of creating the cellulose fibers for insulation.

### Preparation of Fire-Retardant Composition

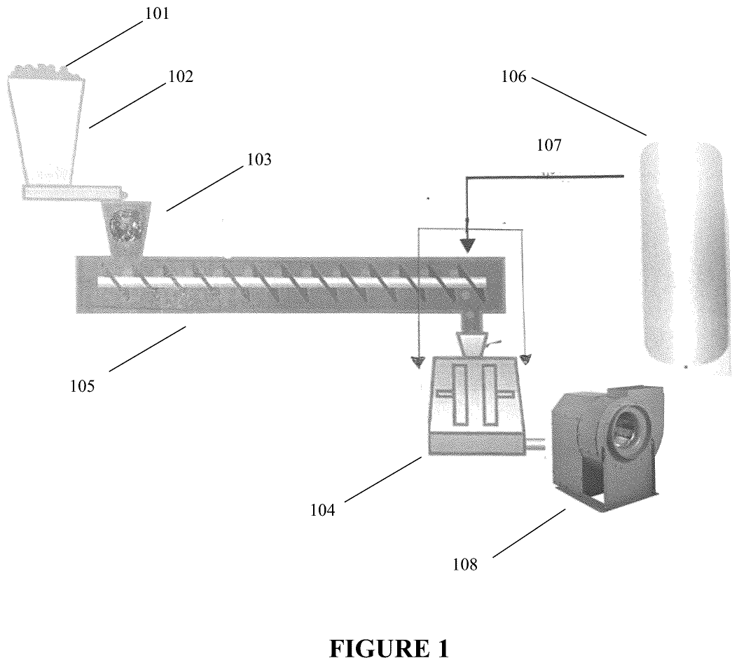

FIG. 1 depicts a schematic view of a process and equipment for preparation of the Fire-Retardant composition.

Fire retardant chemicals (borate compound, urea, optional surfactant and inert materials) may be provided either in bulk tankers or super sacks. The fire-retardant chemicals are conveyed from either storage tanks or by totes and blended according to the required formulation. The mixture of fire retardant chemicals 101 are metered into a weigh feeder 102 and chemicals metered into a chemical pulverizer 103, such as a Reynolds 28 H Pulveriser, maintaining a temperature and air flow for the correct sizing. The chemicals can be introduced individually or blended prior to entering the chemical mill. The individual chemical or the blended mixture can be metered either gravimetrically or volumetrically directly into the feed opening of the chemical mill 104 via conveyor 105. The chemical mills are operated at an output temperature of 65° F.-110° F. (18° C. -43° C.) and do not exceed 120° F. (50° C.). The chemical mill's drive motor is slowed from 60 to 50 hertz and the motor is further slowed by changing sheaves, so the mill 104 operates at 2,000-2,500 RPM. The chemicals are milled in the presence of an air flow 107 that is about 10% higher than the typical cubic feet per minute used which ranges from 1,200 to 2,500 CFM. Temperature can be controlled by, for example, providing cooled air from an air conditioner 106 which can provide air at 65° F. (18° C.) at a flow of about 4,000 cubic feet per minute (CFM). Other chilling systems and methods may be used to maintain the desired temperature during milling. Once the fire retardant composition is milled to the correct particle size, it is pneumatically conveyed for blending with cellulose fibers using, for example, fan 108, which may be operated at, for example, 2,200 CFM.

After milling, the fire retardant composition is pneumatically conveyed through the material handling fan 108 and introduced into the shredded cellulose insulation fibers in a duct immediately after the disc refiner. The fire retardant composition and fibers are then blended using a blower.

The finished treated insulation is pneumatically conveyed through a material handling fan into a cyclone atop a fiber metering tank with the finished insulation material falling into the fiber metering tank and the dirty air going to a dust filtering system. The fiber metering tank mechanically augers the insulation fibers into the packaging system, such as a Rethceif packaging unit.

The packaging system compresses the finished insulation that is then wrapped, sealed, weighed and into individual bales and conveyed to robotic palletization and transport.

### Exemplary Materials and Properties

Tables 1-5 provide some fire-retardant insulation materials made according to this procedure. Tables 6 and 7 provide testing results for some of the fire-retardant insulation materials that were prepared. In the Tables, Dry Urea setting is the percentage of urea that was tested in the formulation, Feeder setting is the setpoint speed for the volumetric feeder that disperses the urea into the chemical grinder, CRF pass point of 38 centimeters, equates to a measurement to meet the 0.12 watts/cm/sq that complies with the industry standard ASTM C739-21 for fire resistance, and Conditioned CRF (critical radiant flux) is the result after the sample is conditioned for 24 hours at 75 degrees F. at a relative humidity of 50% as in accordance with the standard. Fall back and CRF shift are the comparative results from the initial CRF test at the time of manufacture. Blow trials are the results of actual blowing of the samples the same as an installer to measure the product coverage and comparative dust levels.

In Tables 1-7 some samples use the following abbreviations: “T-80”: Polysorbate 80 (a polyoxyethylene sorbitan monooleate); “Reg Surfactant”: Tergitol™ NP-30; “Dry Surfactant”: Hydretain® ES Plus Granular QD; “Helena”: Helena Kinetic@; “Dawn”: name Dawn® Ultra Dishwashing Liquid; “BA”: orthoboric acid; and “UR”: urea. Surfactant, when present, is added at an amount of about 3 wt %, of the fire retardant composition (identified in the tables as the Dry Urea setting).

Fire-retardant insulation materials made according to the above procedure met or exceeded ASTM C739 testing standards and passed ASTM C739 testing for corrosiveness and fungi resistance. Fire-retardant insulation materials made according to the above procedure met or exceeded the testing requirements outlined in Federal Register 16 CFR Ch. II, Part 1209 —Interim Safety Standard For Cellulose Insulation and GSA specification HH-1-515D.

TABLE 1

| Sample | 1 | | 2 | | 3 | | 4 | | 5 | | 6 | |
|---|---|---|---|---|---|---|---|---|---|---|---|---|
| Dry Urea | BA70/30UR | | BA70/30UR | | BA70/30UR | | BA70/30UR | | BA70/30UR | | BA70/30UR | |
| setting | | | | | | | | | | | | |
| Chemical | 12% | | 12% | | 13% | | 13% | | 13% | | 13% | |
| loading % | | | | | | | | | | | | |
| Feeder Setting | 288 | | 288 | | 300 | | 300 | | 300 | | 300 | |
| RPM | 1730 | | 2530 | | 2530 | | 2530 | | 2530 | | 2530 | |
| HZ | 40 | | 70 | | 70 | | 70 | | 70 | | 70 | |
| Temp | 75 | F. | 84 | F. | 84 | F. | 88 | F. | 90 | F. | 91 | F. |
| Moisture | 7.9 | | 8.3 | | 8.3 | | 8.70% | | 9.2 | | 8.1 | |
| CRF pass | 59 | cm | 51 | cm | 42.5 | cm | 40 | cm | 44 | cm | 44 | cm |

| point 38 cm | | | | | | |
|---|---|---|---|---|---|---|
| PH | 6.5 | 7.2 | 7.2 | 7.5 | 6.9 | 7 |
| Condition | 24 hr .120 | 24 hr .120 | 26 hr .120 | 24 hr .120 | 24 hr .120 | 24 hr .120 |
| CRF test | 48 hr .120 | 48 hr .120 | 48 hr .120 | 48 hr .120 | 48 hr .120 | 48 hr .120 |
| Condition | 25 hr 1.23 | 24 hr 1.23 | 24 hr 1.23 | 24 hr 1.23 | 24 hr 1.23 | 24 hr 1.23 |
| Density | 48 hr 1.35 | 48 hr 1.35 | 48 hr 1.35 | 48 hr 1.35 | 48 hr 1.35 | 48 hr 1.35 |

TABLE 2

| Sample | 7 | 8 | 9 | 10 | 11 | 12 | 13 |
|---|---|---|---|---|---|---|---|
| Dry Urea | BA60/40UR | BA60/40UR | BA60/40UR | BA60/40UR | BA60/40UR | BA60/40UR | BA60/40UR |
| setting | | | | | | | |
| Chemical | 12% | 12% | 13% | 13% | 13% | 13% | 13% |
| loading % | | | | | | | |
| Feeder | 295 | 295 | 310 | 350 | 350 | 350 | 350 |
| Setting | | | | | | | |
| RPM | 2700 | 2700 | 2700 | 2700 | 2700 | 2700 | 2700 |
| HZ | 58 | 58 | 58 | 58 | 58 | 58 | 58 |
| Temp | 101 | 98 F. | 94 F. | 94 | 105 F. | 105 F. | 100 |
| Moisture | 9.2 | 8.3 | 7.4 | 8.2 | 7.7 | 9.2 | 9.00 |
| CRF pass | 44.9 | 46.5 | 52.4 | 51.8 | 57.2 | 50.5 | 47.1 |
| point | | | | | | | |
| 38 cm | | | | | | | |
| Fall Back | 22.1 | 18.4 | 20.4 | 12.3 | 16.3 | 9.2 | 15.6 |
| — | 51% | 60% | 61% | 76% | 72% | 82% | 67% |
| 24 hour | 22.8 | 28.1 | 32 | 39.5 | 40.9 | 41.3 | 31.5 |
| Condition | | | | | | | |
| CRF test | | | | | | | |
| Moisture | 8.2 | 8 | 7.7 | | | | 8.4 |
| 48 hour | 26.9 | 25.6 | 35.9 | 43 | 43 | 36.3 | 35.2 |
| Condition | | | | | | | |
| CRF test | | | | | | | |
| 72 Hour | 22.8 | 28.3 | 32 | 39.5 | 40.7 | 34.9 | 29.5 |
| Condition | | | | | | | |
| CRF test | | | | | | | |
| Moisture | 8.4 | | | | | | |

TABLE 3

| Sample | 14 | 15 | 16 | 17 | 18 | 19 | 20 |
|---|---|---|---|---|---|---|---|
| Dry Urea | 60BA/40UR | 60BA/40UR | 60BA/40UR | 60BA/40UR | 60BA/40UR | 60BA/40UR | 50/50 Reg |
| setting | | | Dry | Dry | T80 | T80 | Surfactant |
| | | | Surfactant | Surfactant | | | |
| Chemical | 14% | 14% | 14% | 14% | 14% | 14% | 14% |
| loading | | | | | | | |
| % | | | | | | | |
| Feeder | 305 | 305 | 305 | 305 | 305 | 305 | 305 |
| Setting | | | | | | | |
| RPM | 2700 | 2700 | 2700 | 2700 | 2700 | 2700 | 2700 |
| HZ | 58 | 58 | 58 | 58 | 58 | 58 | 58 |
| Temp | 95 | 95 | 95 | 95 | 95 | 95 | 95 |
| Moisture | 7.6 | 8.1 | 8.2 | 9.00 | 6.7 | 8.3 | 6.40% |
| CRF pass | 47.7 | 53.0 | 57.0 | 55.8 | 49.0 | 48.5 | 47.5 |
| point | | | | | | | |
| 39.4 cm | | | | | | | |
| Density | 1.60 | 1.45 | | 1.51 | | 1.47 | |
| ph | 7.20 | 6.80 | 6.90 | 6.90 | 7.20 | 7.00 | 7.1 |
| Fall Back | 12.3 | 7.5 | 9 | 14 | 6.7 | 9.3 | 7.1 |
| Moisture | 8.9 | 7.2 | 7.8 | 7.8 | 8.2 | 8.2 | 8.1 |
| 48 hour | | 45 | 49 | | | | |
| Condition | | | | | | | |
| CRF test | | | | | | | |

TABLE 4

| Sample | 21 | 22 | 23 | 24 | 25 | 26 | 27 |
|---|---|---|---|---|---|---|---|
| Dry Urea | 50BA/50UR | 50BA/50UR | 50BA/50UR | 50BA/50UR | 50BA/50UR | 50BA/50UR | 50BA/50UR |
| setting | Reg | Surfactant | Surfactant | Surfactant | Surfactant | Surfactant | Surfactant |
| | Surfactant | Helena | Helena | Helena | Helena | Helena | Helena |
| Chemical | 14% | 14% | 14% | 14% | 13% | 12% | 11% |
| loading % | | | | | | | |
| Feeder | 305 | 305 | 305 | 305 | 280 | 260 | 240 |
| Setting | | | | | | | |
| RPM | 2700 | 2700 | 2700 | 2700 | 2700 | 2700 | 2700 |
| HZ | 58 | 58 | 58 | 58 | 58 | 58 | 58 |
| Temp | 95 | 98 | 98 | 98 | 98 | 98 | 98 |
| Moisture | 6.5 | 8.1 | 8.0 | 9.3 | 6.20 | 8.6 | 6.2 |
| CRF pass | 43.5 | 41.4 | 45.5 | 37.6 | 38.4 | 44.5 | 52 |
| point | | | | | | | |
| 39.4 cm | | | | | | | |
| Density | 1.59 | | 1.68 | | | | |
| ph | 7.1 | 6.8 | 7.2/7.4 | 7.2 | 7.5/7.7 | 7.5/7.6 | 7.5/7.7 |
| Fall Back | 12.2 | | 7.0 | | 2.4 | 2.6 | 17.4 |
| 24 hour | 31.3 - 27% | | 38.5 - 15% | | 36 - 6% | 41.9 -5% | 34.6- 33% |
| Condition | | | | | | | |
| CRF test | | | | | | | |
| Moisture | 7.2 | | 7.3 | | 7.3 | 7.7 | 8.1 |
| 48 hour | | | | | | 36 | |
| Condition | | | | | | | |
| CRF test | | | | | | | |
| 72 Hour | | | A- Blow | | | B2 -Blow | |
| Condition | | | trial | | | trial | |
| CRF test | | | | | | | |

TABLE 5

| Sample | 28 | 29 | 30 | 31 | 32 |
|---|---|---|---|---|---|
| Dry Urea | 60UR/40BA | 60UR/40BA | 60Ur/40BA | 60UR/40BA | 60UR/40 BA all |
| setting | Reg | Reg Surfactant | Dawn | No Surfactant | Brown with double |
| | Surfactant | Helena | Surfactant | Helena oil | surfactant |
| | Helena | | Helena | | |
| Chemical | 12% | 12% | 12% | 12% | 12% |
| loading % | | | | | |
| Feeder Setting | 260 | 260 | 260 | 260 | 220 |
| RPM | 2700 | 2700 | 2700 | 2700 | 2700 |
| HZ | 58 | 58 | 58 | 58 | 58 |
| Temp | 100 | 98 | 97 | 97 | 97 |
| Moisture | 8 | 8.2 | 8.7 | 7.8 | 9 |
| CRF pass point | 43.8 | 28.5 | 47.3 | 51.6 | 46.5 |
| 39.4 cm | | | | | |
| Density | | 1.86 | | | |
| pH | 7.1/ 7.7 | 7.3 | 7.3 /7.4 | 7.3 | 7.6 |
| Fall Back | 9.3 | | 12.2 | 0.1 | 3 |
| 24 hour | 34.5-21% | | 35.1/26% | 51.5 | 43.5 |
| Condition CRF | | | | | |
| test | | | | | |
| Moisture | 7.65 | | 7.8 | | |
| 72 Hour | B-Blow | | D-Blow trial | | |
| Condition CRF | trials | | | | |
| test | | | | | |

TABLE 6

| | Test 1 | Test 2 | | Test 3 | | Test 4 | | Test 5 | |
|---|---|---|---|---|---|---|---|---|---|
| | Boric | Boric | | Boric | | Boric | | | Boric |
| FORMULA | Acid | Acid | Urea | Acid | Urea | Acid | Urea | Urea | Acid |
| % | 1 | 0.3 | 0.7 | 0.3 | 0.7 | 0.3 | 0.7 | 0.3 | 0.7 |
| LOADING | 0.1 | 0.12 | | 0.12 | | 0.12 | | 0.12 | |
| CHEMICAL/ | 2.5 | 0.9 | 2.1 | 0.9 | 2.1 | 0.9 | 2.1 | 0.9 | 2.1 |
| BAG | | | | | | | | | |
| CRF | 0.09 | 0.6 | | 0.127 | | 0.13 | | 0.15 | |
| DENSITY | 1.9 | 1.8 | | 2 | | 1.9 | | 1.98 | |
| MOISTURE | 0.1 | 85 | | 0.07 | | 0.08 | | 0.07 | |
| SMOLDER | Pass | Pass | | Pass | | Pass | | Pass | |
| PH | 6.7 | 6.7 | | 6.5 | | 6.7 | | 6.7 | |
| Chemical mill | 60 | 55 | | 55 | | 55 | | 55 | |
| HZ | | | | | | | | | |
| Chemical fan | 40 | 50 | 50 | 50 | | 50 | | 50 | |
| HZ | | | | | | | | | |
| Temp | 110 | 110 | | 115 | | 120 | | 115 | |

TABLE 7

| | | | CHEMICAL/ | | | | | |
|---|---|---|---|---|---|---|---|---|
| FORMULA | % | LOADING | BAG | CRF | DENSITY | MOISTURE | SMOLDER | PH |
| Test 1 | | | | | | | | |
| Test 1 | 70/30 | 0.12 | 0.9 | 0.08 | 1.911 | 0.06 | Pass | 6.7 |
| Condition | | | | | | | | |
| | | | 2.1 | | | | | |
| Test 2 | | | | | | | | |
| Test 2 | 70/30 | 0.12 | 0.9 | 0.195 | | 0.07 | Pass | 6.8 |
| Condition | | | | | | | | |
| | | | 2.1 | | | | | |
| Test 3 | 70/30 | 0.12 | 0.9 | 0.143 | 1.85 | 0.07 | Pass | 6.7 |
| Test Condition | | | 2.1 | | | | | |
| Test 4 | 70/30 | 0.12 | 0.9 | 0.134 | 1.88 | 0.06 | Pass | 6.9 |
| Test Condition | | | 2.1 | | | | | |
| Test 4 | 70/30 | 0.12 | 0.9 | 205 | | 0.07 | Pass | 6.7 |
| Test Condition | | | 2.1 | | | | | |

The embodiments illustrated and discussed in this specification are intended only to teach those skilled in the art how to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of any and all claims supported herein and their equivalents, the invention may be practiced otherwise than as specifically described.

What is claimed is:

1. A fire-retardant composition comprising:
a borate compound and urea in a weight ratio ranging from 15:85 to 85:15, and
from 0 weight % to 3 weight % of a surfactant by total weight of the fire-retardant composition, and
wherein the weight % of the borate compound plus the weight % of urea ranges from 50% to 100% of the fire-retardant composition.

2. The fire-retardant composition of claim 1, wherein the borate compound is selected from the group consisting of a borate salt, orthoboric acid and borax.

3. The fire-retardant composition of claim 2, wherein the borate compound is orthoboric acid.

4. The fire-retardant composition of claim 1, comprising:
15 weight percent to 85 weight percent of the borate compound and 85 weight percent to 15 weight percent of the urea.

5. The fire-retardant composition of claim 4, wherein the borate compound is orthoboric acid.

6. The fire-retardant composition of claim 1, comprising an amount of the surfactant wherein the surfactant is a non-ionic surfactant.

7. The fire-retardant composition of claim 6, wherein the surfactant is a compound having the formula: 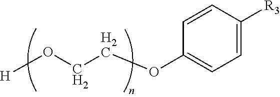
wherein R is a linear or branched hydrocarbon and n ranges from 5 to 100.

8. The fire-retardant composition of claim 1, wherein the weight % of the borate compound the plus the weight % of urea ranges from 97% to 100%.

9. The fire-retardant composition of claim 8, wherein the weight % of the surfactant ranges from 1% to 3%.

10. The fire-retardant composition according to claim 1, consisting essentially of:
a borate compound and urea in a weight ratio ranging from 15:85 to 85:15, and from 0 weight % to 3 weight % of a surfactant by total weight of the fire-retardant composition.

11. A fire-retardant insulation material consisting of:
cellulose fiber insulation, and
the fire-retardant composition of claim 1;
wherein the fire-retardant insulation material is formulated to have a fire-retardance that meets or exceeds ASTM C739 testing standards.

12. The fire-retardant insulation material of claim 11, wherein the fire-retardant insulation material has:
from 85 weight % to 90 weight % of the cellulose fiber insulation by total weight of the fire-retardant insulation material, and
from 10 weight % to 15 weight % of the fire-retardant composition by total weight of the fire-retardant insulation material.

13. The fire-retardant insulation material of claim 11, wherein the fire-retardant insulation material is formulated to have a fungi resistance that meets or exceeds ASTM 739 testing standards.

14. The fire-retardant insulation material of claim 11, wherein the fire-retardant insulation material is formulated to have a corrosion resistance that meets or exceeds ASTM 739 testing standards.

15. The fire-retardant insulation material of claim 11, wherein the cellulose fiber insulation comprises recycled cellulose.

16. The fire-retardant insulation material of claim 11, wherein the cellulose fiber insulation consists of recycled cellulose.

17. The fire-retardant insulation material of claim 11, wherein the cellulose fiber insulation has a cellulose fiber size ranging from 0.25 inches to 0.50 inches.

18. A process for preparing a fire-retardant insulation material, wherein the process comprises:
shredding a reclaimed cellulose feedstock to obtain a shredded cellulose material having a fiber size ranging from 0.5 inches to 3 inches,
milling a fire-retardant composition of claim 1, and
contacting the shredded cellulose material the milled fire-retardant composition to obtain the fire-retardant insulation material.

19. The process of claim 18, wherein fire-retardant composition is milled at a temperature ranging from 65° F. to 120° F.

20. The process of claim 18, wherein fire-retardant composition is milled at 2,000 to 2,500 revolutions per minute in the presence of 1,300 to 2,500 cubic feet per minute of airflow.
